(19) United States
(12) Patent Application Publication
(10) Pub. No.: US 2022/0035695 A1
(43) Pub. Date: Feb. 3, 2022

(54) COMPUTER UNIT, COMPUTER SYSTEM AND EVENT MANAGEMENT METHOD

(71) Applicant: Hitachi, Ltd., Tokyo (JP)

(72) Inventors: Akihiro HARA, Tokyo (JP); Akira DEGUCHI, Tokyo (JP); Tsukasa SHIBAYAMA, Tokyo (JP)

(73) Assignee: Hitachi, Ltd., Tokyo (JP)

(21) Appl. No.: 17/172,177

(22) Filed: Feb. 10, 2021

(30) Foreign Application Priority Data
Aug. 3, 2020 (JP) 2020-131485

(51) Int. Cl. G06F 11/07

(52) U.S. Cl. CPC G06F 11/079; G06F 11/0772; G06F 11/0751

(57) ABSTRACT

A computer system includes at least one HCI node, and a high-order management infrastructure which is communicable with the HCI node, and acquires operation information of the HCI node for detecting abnormality in the computer unit. The HCI node generates an event notification table including a resource of the HCI node relevant to an event executed therein, and a type of influence of the event to the HCI node, and transmits the event notification table to the high-order management infrastructure. The operation information includes a load to the resource of the HCI node. The high-order management infrastructure detects abnormality using the operation information and the event notification table.

### BACKGROUND

The present invention relates to a computer unit, a computer system, and an event management method.

As importance of information processing systems serving as bases for corporate activities and infrastructures has been growing, various techniques are under development for the purpose of detecting faults in the information processing system at earlier stages, or analyzing the fundamental cause of the fault to take rapid execution of countermeasures for application to the system operation management tasks. Recently, the importance of the fault sign detection techniques that allow detection of the sign of the fault before such fault occurs has been attracting attention (for example, see Japanese Unexamined Patent Application Publication No. 2014-134987).

The system for monitoring a plurality of systems to be monitored as disclosed in Japanese Unexamined Patent Application Publication No. 2014-134987 is configured to “receive measurement values of indexes, designate the estimation model for estimating the future measurement value of the reference index from a plurality of estimation models with reference to the received measurement values, estimate the estimation value of the reference index, generate or update the Bayesian network targeting the reference index and the target index, and calculate the probability that the measurement value of the target index becomes the predetermined value or in the predetermined value range.”

Recently, the forgoing fault sign detection technique has been demanding the approach to detect the fault sign using AI (Artificial Intelligence) technology such as machine learning. Especially in the currently employed system called HCI (Hyper-Converged Infrastructure), the number of resource types is increased (for example, VM: Virtual Machine). Accordingly, the importance of the fault sign detection technique has been growing. The HCI is the system that allows the single node to execute a plurality of sets of processing by operating the application, middleware, management software, and container besides the storage software on the OS or hypervisor installed in each node.

### SUMMARY

The fault sign detection technology through the machine learning causes the learning model to notify the user of the behavior change (change caused by the software update or the like) as the abnormality. Actually, such behavior change is within the expectation range for the user. Accordingly, the user has to take much time for confirming each notified event. In the case where the data having the fault occurring are input to the model intended to learn the normal state for the learning purpose, the accuracy of the model is deteriorated when it is used for detecting abnormality. In order to reduce time, and prevent deterioration of accuracy in the foregoing circumstances, it is necessary to implement the method of suppressing erroneous learning and erroneous detection owing to the input data unsuitable for learning and detection.

The present invention provides the computer unit, the computer system, and the event management method for ensuring to lessen the confirmation task caused by the intrinsically unnecessary notification when executing the abnormality detection function based on the learning model.

According to an aspect of the present invention, at least one computer unit is provided in a computer system including a management server which is configured to be communicable with the computer unit, and to acquire operation information of the computer unit for executing an abnormality detection of the computer unit. The computer unit has a processor which generates an event notification table including a type of the event executed in the computer unit, the resource of the computer unit relevant to the event, the influence of the event to the computer unit, and a period of the influence, and transmits the event notification table to the management server. The management server executes the abnormality detection of the computer unit using the operation information and the event notification table.

The present invention allows lessening of the confirmation task caused by the intrinsically unnecessary notification when executing the abnormality detection function based on the learning model.

### BRIEF DESCRIPTION OF THE DRAWINGS

FIG. 1 illustrates an entire structure of a computer system according to a first example;

FIG. 2 is a block diagram of an example of a hardware structure of the computer system according to the first example;

FIG. 3 illustrates programs and tables on a memory of an HCI node of the computer system according to the first example;

FIG. 4 illustrates programs and a table on a memory of a high-order management infrastructure of the computer system according to the first example;

FIG. 5 illustrates a structure of an event log of the computer system according to the first example;

FIG. 6 illustrates a structure of an event-type table of the computer system according to the first example;

FIG. 7 illustrates a structure of a software update management table of the computer system according to the first example;

FIG. 8 illustrates a structure of a load information table of the computer system according to the first example;

FIG. 9 illustrates a structure of an operation information table of the computer system according to the first example;

FIG. 10 illustrates an example of a transitional estimation value of a CPU utilization of the computer system according to the first example;

FIG. 11 illustrates another example of the transitional estimation value of the CPU utilization of the computer system according to the first example;

FIG. 12 illustrates a structure of a structure information table of the computer system according to the first example;

FIG. 13 illustrates a structure of an event management table of the computer system according to the first example;

FIG. 14 illustrates a structure of an event notification table of the computer system according to the first example;

FIG. 15 illustrates a structure of a learning model management table of the computer system according to the first example;

FIG. 16 is a flowchart representing event processing steps executed in the computer system according to the first example;

FIG. 17 is a flowchart representing influence range estimation processing steps executed in the computer system according to the first example;

FIG. 18 is a flowchart representing influence range identification processing steps executed in the computer system according to the first example;

FIG. 19 is a flowchart representing influence end time point estimation processing steps executed in the computer system according to the first example;

FIG. 20 is a flowchart representing input determination processing steps executed in the computer system according to the first example;

FIG. 21 illustrates a structure of an operation information table of a computer system according to a second example;

FIG. 22 is a flowchart representing event processing steps executed in the computer system according to the second example;

FIG. 23 is a flowchart representing input determination processing steps executed in the computer system according to the second example; and

FIG. 24 is a flowchart representing input determination processing steps executed in the computer system according to a third example.

### DETAILED DESCRIPTION

An embodiment of the present invention will be described referring to the drawings. The invention is not limited to embodiments to be described herein, and all the elements and combinations of the embodiments to be described herein are not necessarily essential for solutions provided by the present invention.

In the following explanation, the “memory” refers to one or more memories which may be typically a main storage device. At least one memory of the memory unit may be of either volatile or non-volatile type.

In the following explanation, the “processor” refers to one or more processors. At least one processor may be typically a microprocessor such as CPU (Central Processing Unit). However, the processor may be of other type such as GPU (Graphics Processing Unit). At least one processor may be of either single-core type or multi-core type.

At least one processor may be the processor in the broad sense, for example, hardware circuits (for example, FPGA (Field-Programmable Gate Array) or ASIC (Application Specific Integrated Circuit)) for executing the processing partially or entirely.

In the disclosure, the storage unit (device) includes a single unit of storage drive such as a single unit of HDD (Hard Disk Drive) and SSD (Solid State Drive), a RAID device including a plurality of storage drives, and a plurality of RAID devices. If the HDD is employed for the drive, it is possible to include, for example, the SAS (Serial Attached SCSI) HDD, and the NL-SAS (nearline SAS) HDD.

In the following explanation, the expression “xxx table” refers to the information to be output in response to an input operation. The information may be data with an arbitrary structure, and a learning model for generating outputs in response to the input operation such as the neural network. Accordingly, it is possible to reword the “xxx table” into the “xxx information”.

In the following explanations, an example of each structure of the tables will be described. It is possible to divide the single table into two or more tables. Alternatively, two or more tables may entirely or partially constitute the single table.

The following explanation will be made on the assumption that the “program” executes the processing. The program is executed by the processor so that the predetermined processing is implemented appropriately using storage resources (for example, memory) and/or communication interface devices (for example, port). Accordingly, the use of the “program” as the subject for executing the processing may be regarded as adequate. The processing to be executed by the program as described herein may be paraphrased as the processing to be executed by the processor or the computer having the processor.

The program may be installed in the device such as the computer, in the program distribution server, or in the recording medium (for example, nontemporary type) that can be read by the computer. In the following explanation, two or more programs may be implemented as one program, or one program may be implemented as two or more programs.

In the drawings for explanation of examples, the element with the same function will be denoted by the same code, and repetitive explanation thereof, thus will be omitted.

In the following explanation, the specific element that is not intended to be discriminated from other elements may be denoted by the reference code (or common code of the reference codes). The specific element that is intended to be discriminated from other elements may be denoted by the identification number (or reference code) of the specific element.

In some cases, positions, sizes, shapes, ranges and the like of the respective components illustrated in the drawings do not reflect actual positions, sizes, shapes, ranges and the like. The present invention is not necessarily limited to the positions, sizes, shapes, and ranges as disclosed in the drawings.

### FIRST EXAMPLE

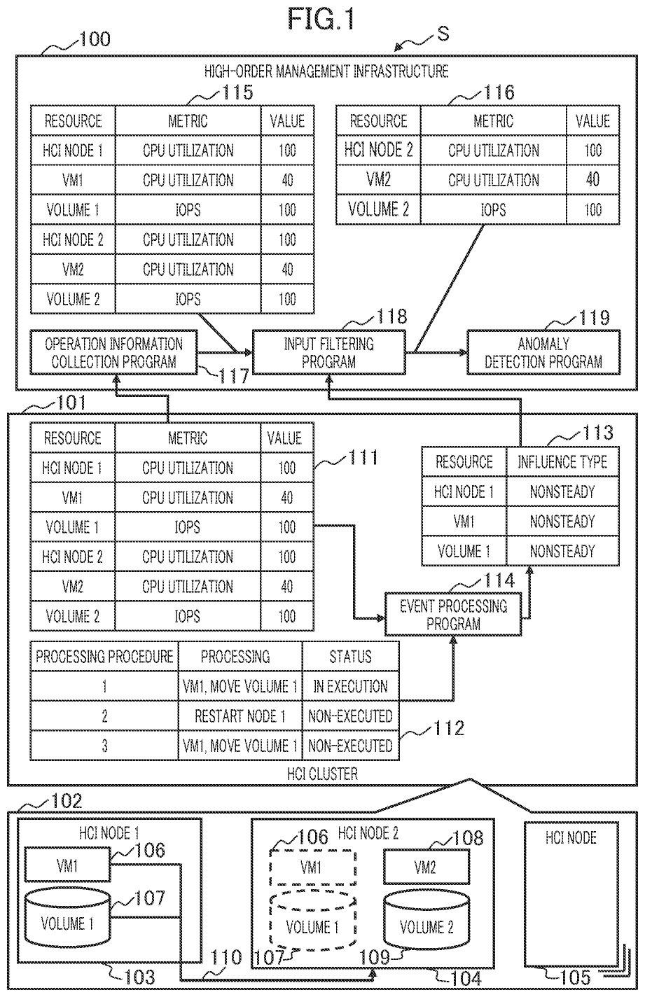

FIG. 1 illustrates an entire structure of a computer system according to a first example.

Referring to FIG. 1, a computer system S includes an HCI cluster 101 and a high-order management infrastructure (management server) 100.

In the HCI cluster 101, a cluster 102 is constituted by a plurality of HCI nodes (computer units) 103, 104, 105 in cooperation with one another. FIG. 1 illustrates three units of HCI nodes 103 to 105. However, the HCI cluster 101 may be constituted by two, or three or more HCI nodes.

The HCI nodes 103 to 105 include VMs 106, 108, and volumes 107, 109, respectively as an example of the logical configuration. In the example of FIG. 1, software update is executed in the HCI node 103, and then the VM 106 and the volume 107 of the HCI node 103 are temporarily moved to the HCI node 104.

The HCI cluster 101 generates an operation information table 111 for periodically recording its own operation status. The HCI cluster 101 includes a software update management table 112 executing the software update in the HCI cluster 101. An event processing program 114 generates an event notification table 113 based on the operation information table 111 and the software update management table 112.

The HCI cluster 101 transmits the operation information table 111 and the event notification table 113 to the high-order management infrastructure 100 periodically or in response to the request from the high-order management infrastructure 100. An operation information collection program 117 of the high-order management infrastructure 100 sends the operation information table 115 transmitted from the HCI cluster 101 to an input filtering program 118. Based on the operation information table 115 and the event notification table 113 transmitted from the HCI cluster 101, the input filtering program 118 extracts operation information of the HCI cluster 101, which is required to be input to an anomaly detection program 119.

In the example of FIG. 1, the software update is executed in the HCI cluster 101. The software update in itself is executed based on the software update management table 112 periodically, or in response to the instruction of the system manager. The non-abnormal state of the HCI cluster 101 is considered as change in behavior as expected. In the event notification table 113 generated by the HCI cluster 101, influence types of the resources (HCI node 103, VM 106, volume 107) which involve the software update are in nonsteady states. Detection of the abnormality of the foregoing state by the anomaly detection program 119 should be avoided. Accordingly, based on the operation information table 115 and the event notification table 113, the input filtering program 118 generates an operation information table 116 in which items which should not be input to the anomaly detection program 119 are excluded (the item relevant to the software update of the example in FIG. 1). The generated operation information table 116 is input to the anomaly detection program 119.

The respective tables of FIG. 1 are mere examples, and detailed explanations thereof will be described later.

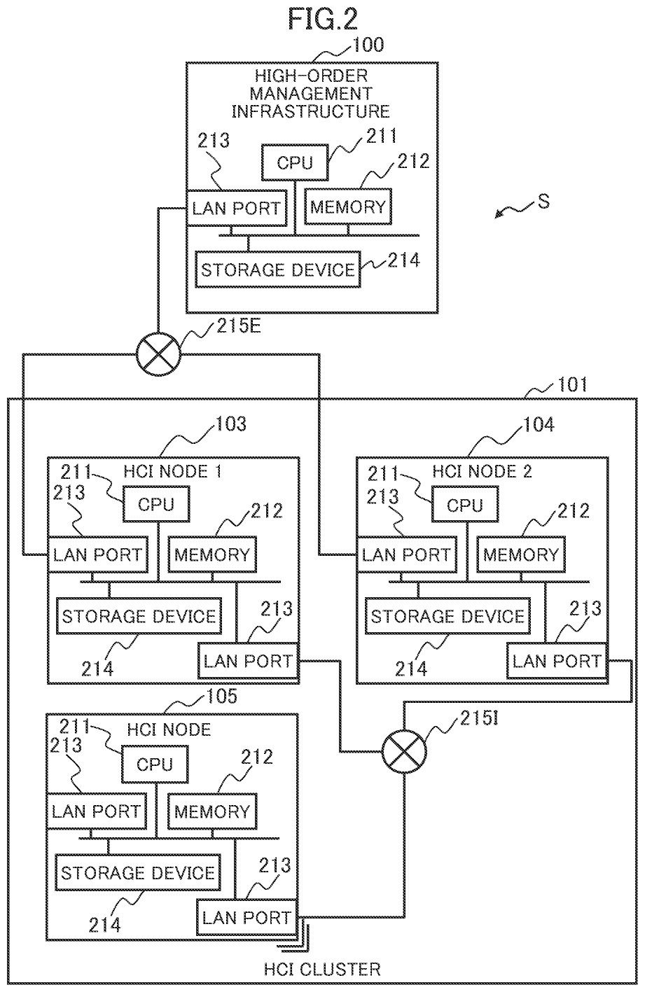

FIG. 2 is a block diagram of an example of a hardware structure of the computer system S according to the first example.

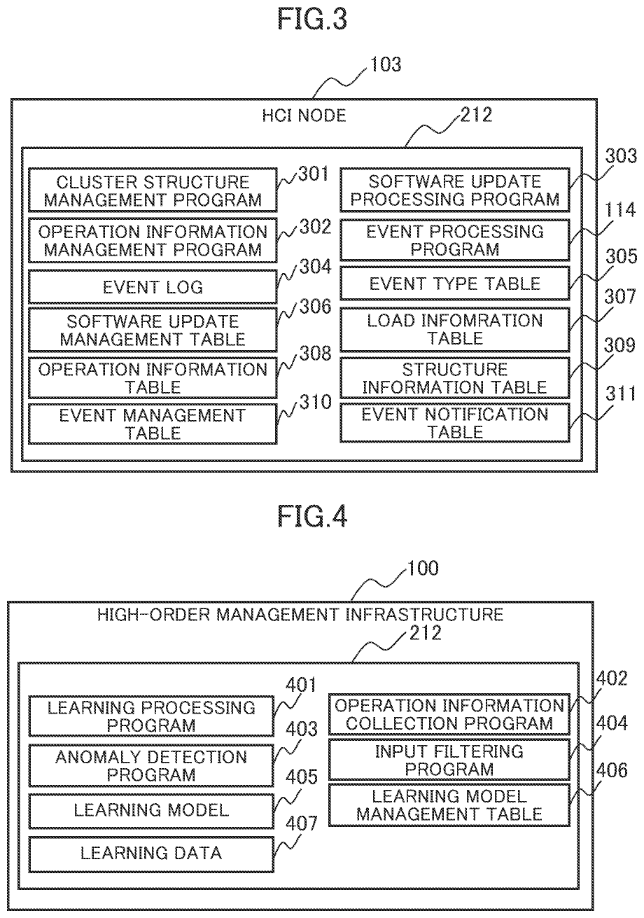

Referring to FIG. 2, the computer system S includes the HCI cluster 101 and the high-order management infrastructure 100. The HCI cluster 101 includes the plurality of HCI nodes 103 to 105. Those HCI nodes 103 to 105 are operated integrally through execution of a cluster structure management program 301 (see FIG. 3) so that the HCI cluster 101 is constituted. The number of the HCI nodes 103 to 105 is three as illustrated in FIG. 2. However, the HCI cluster 101 may be constituted by two, or three or more HCI nodes.

The respective HCI nodes 103 to 105 are line connected to a LAN (Local Area Network) 2151. The HCI cluster 101 and the high-order management infrastructure 100 are line connected to a LAN 215E.

The HCI nodes 103 to 105 and the high-order management infrastructure 100 include CPUs 211 as processors, memories 212, LAN ports 213, and storage devices 214, respectively. The CPU 211, the memory 212, the LAN port 213, and the storage device 214 are connected to one another via a bus.

The memory 212 is a main storage unit that can be read and written by the CPU 211. The memory 212 is a semiconductor memory, for example, SRAM or DRAM. The memory 212 secures the work area where the program in execution is stored by the CPU 211, and the program is executed by the CPU 211.

The storage device 214 is a secondary storage unit that can be read and written by the CPU 211. The storage device 214 is a hard disk device or an SSD (Solid State Drive), for example. The storage device 214 is capable of retaining the volume for storing executable files of various programs and data or duplicate data for executing programs, and the volume for storing cache data.

The storage device 214 may be constituted by a plurality of hard disk devices and SSDs using such technique as RAID (Redundant Arrays of Independent Disks).

The CPU 211 executes the program (for details, see FIG. 3 and FIG. 4) stored in the memory 212. The CPU 211 connected to the LAN port 213 via the bus is capable of transmitting/receiving data to/from the other storage node and the high-order management infrastructure 100 via the LAN 215I, LAN 215E, and lines.

In FIG. 2, the HCI cluster 101 and the high-order management infrastructure 100 are configured separately. The function of the high-order management infrastructure 100 may be implemented by the HCI node 103.

FIG. 3 represents programs and tables in the memory 212 of the HCI node 103 of the computer system S according to the first example. Each of the programs and tables stored in the memory 212 of the HCI node 103 in FIG. 3 has the same structure (not necessarily the same content) for any of the HCI nodes 103 to 105.

The memory 212 of the HCI node 103 stores the cluster structure management program 301, an operation information management program 302, a software update processing program 303, and an event processing program 114.

In the HCI node 103, the cluster structure management program 301 is executed to integrally operate a plurality of HCI nodes as the HCI cluster 101. The operation information management program 302 monitors the operation status of the HCI node 103 periodically or for every execution of the event to generate an operation information table 308. The software update processing program 303 executes software update of the HCI node 103 based on a software update management table 306 to be described later. An event processing program 114 generates an event management table 310 based on the operation information table 308, and an event notification table 311 based on the event management table 310. Detailed explanation of operations of the event processing program 114 will be made later.

The memory 212 of the HCI node 103 stores an event log 304, an event type table 305, a software update management table 306, a load information table 307, an operation information table 308, a structure information table 309, the event management table 310, and the event notification table 311. Detailed explanations of those tables will be made later.

FIG. 4 represents programs and a table in the memory 212 of the high-order management infrastructure 100 of the computer system S according to the first example.

The memory 212 of the high-order management infrastructure 100 stores a learning processing program 401, an operation information collection program 402, an anomaly detection program 403, and an input filtering program 404.

The learning processing program 401 generates a learning model 405 using learning data 407 through artificial intelligence technology such as machine learning. The operation information collection program 402 collects the operation information tables 308 transmitted from the HCI cluster 101 periodically, or transmitted from the HCI cluster 101 in response to the request from the operation information collection program 402 so that the collected operation information tables 308 are sent to the input filtering program 404. The anomaly detection program 403 detects whether or not abnormality has occurred in the HCI cluster 101 using the learning processing program 401 and the learning model 405. Based on the operation information table 308 sent from the operation information collection program 402, and the event notification table 311 provided from the HCI cluster 101, the input filtering program 404 extracts the item to be provided to the anomaly detection program 403 from the operation information tables 308 (the item expected to cause no erroneous detection even if it is provided), and provides the extracted item to the anomaly detection program 403.

The memory 212 of the high-order management infrastructure 100 stores the learning model 405, a learning model management table 406, and the learning data 407. Detailed explanation of the learning model management table 406 will be made later.

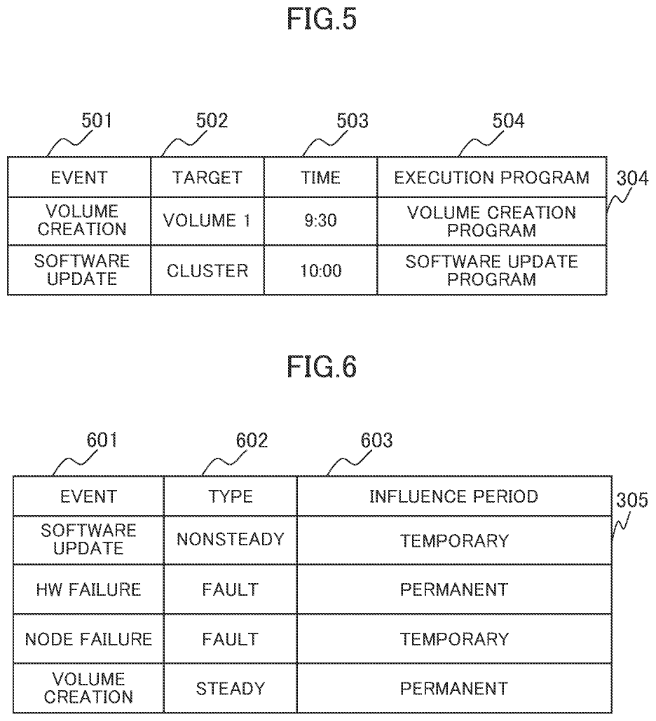

FIG. 5 illustrates a structure of the event log 304 of the computer system S according to the first example.

The event log 304 includes entries of an event 501, a target 502, a time 503, and an execution program 504. The event log 304 is added for each execution of the event in the HCI nodes 103 to 105.

The event 501 refers to a title of the event executed in the HCI nodes 103 to 105. The target 502 refers to a target that involves the event specified by the event 501. The time 503 refers to the time at which the event specified by the event 501 is executed. The execution program 504 refers to a title of the program that executes the event specified by the event 501.

FIG. 6 illustrates a structure of the event type table 305 of the computer system S according to the first example.

The event type table 305 includes entries of an event 601, a type 602, and an influence period 603. The event type table 305 is preliminarily set in the device, but may be changed by managers or users of the HCI cluster 101 and the high-order management infrastructure 100. The event type table is stored in the memories 212 of the HCI nodes 103 to 105.

The event 601 refers to a title of the event to be executed (planned for execution) in the HCI nodes 103 to 105. The type 602 refers to a type of the event specified by the event 601. The type of the event specified by the type 602 is obtained by classifying the event mainly in light of system operations, for example, “steady/nonsteady” and “fault” (in the absence of fault, it will not be specified because the event type is either steady or nonsteady). The influence period 603 receives entry of the duration of the influence resulting from execution of the event. The influence period 603 of the event type table 305 is obtained by classifying the period in light of whether it is temporal or permanent. Actually, the specific influence period will be estimated by the event processing program 114 (detailed explanation will be made later).

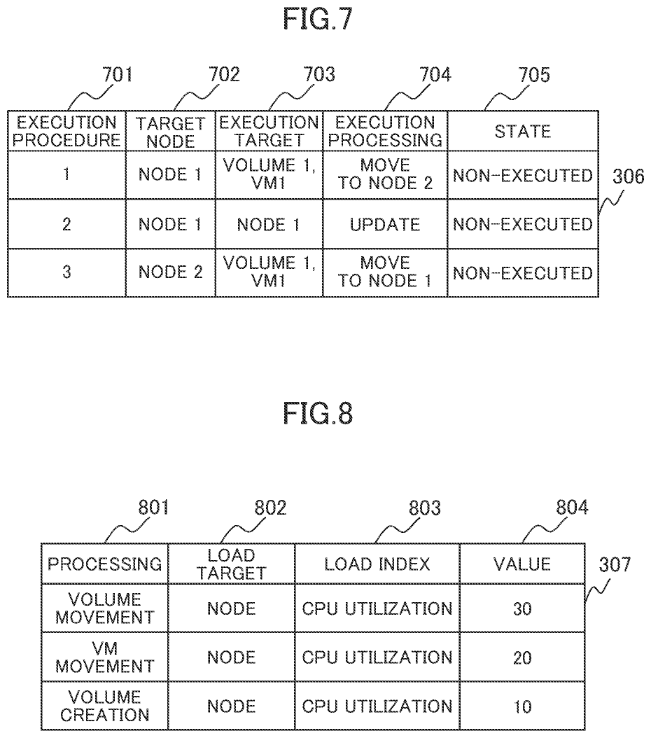

FIG. 7 illustrates a structure of the software update management table 306 of the computer system S according to the first example.

The software update management table 306 includes entries of an execution procedure 701, a target node 702, an execution target 703, an execution processing 704, and a state 705. Upon activation, the software update processing program 303 generates the software update management table 306, and stores the table in the memories 212 of the HCI nodes 103 to 105.

The execution procedure 701 has the respective processing steps for software updating denoted by sequential numbers in ascending order. The target node 702 refers to each number of the HCI nodes 103 to 105 which involve the software updating procedure as specified by the execution procedure 701 (for example, the node 1 refers to the HCI node 103, and the node 2 refers to the HCI node 104). The execution target 703 refers to each inner structure of the HCI nodes 103 to 105 which involve the software updating procedure as specified by the execution procedure 701. The execution processing 704 refers to contents of processing executed in the software updating procedure as specified by the execution procedure 701. The state 705 refers to the state (executed/in execution/not started) where the software updating procedure is executed as specified by the execution procedure 701.

FIG. 8 illustrates a structure of the load information table 307 of the computer system S according to the first example.

The load information table 307 includes entries of a processing 801, a load target 802, a load index 803, and a value 804. The memories 212 of the HCI nodes 103 to 105 store the load information table 307 where default values have been set. In the case of the event which has been executed in the system S before, such value may be updated based on the difference between the values of the operation information table 308 before and after execution of the event.

The processing 801 refers to a title of the processing to be executed in the HCI nodes 103 to 105. The load target 802 refers to the device to which the load is applied by the processing as specified by the processing 801. The load index 803 refers to the type of the index for evaluating the load applied by the processing as specified by the processing 801. The value 804 refers to the value of the load applied by the processing as specified by the processing 801 in accordance with an evaluation index as specified by the load index 803.

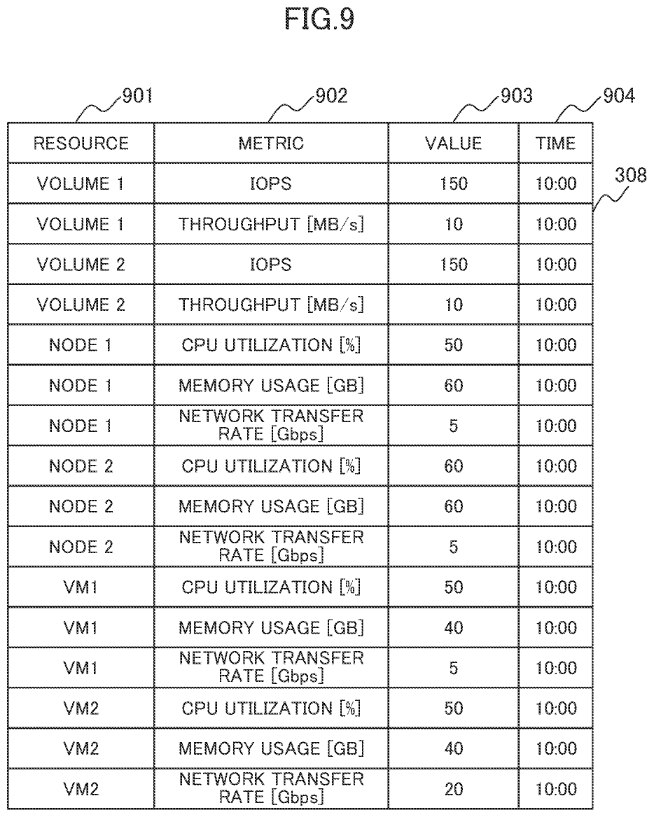

FIG. 9 illustrates a structure of the operation information table 308 of the computer system S according to the first example.

The operation information table 308 includes entries of a resource 901, a metric 902, a value 903, and a time 904.

The resource 901 refers to a title of the resource operating in the HCI cluster 101. The metric 902 refers to a title of the metric for monitoring the operating status of the resource as specified by the resource 901. The value 903 refers to the value of the metric as specified by the metric 902. The time 904 refers to a time stamp marked upon measurement of the value 903.

FIG. 12 illustrates a structure of the structure information table 309 of the computer system S according to the first example.

The structure information table 309 includes entries of a node ID 1201 and an affiliated resource 1202. The structure information table 309 is preliminarily generated by the managers or the users of the HCI cluster 101 and the high-order management infrastructure 100, and stored in the memories 212 of the HCI nodes 103 to 105.

The node ID 1201 refers to each number of the HCI nodes 103 to 105 (for example, the node 1 refers to the HCI node 103, and the node 2 refers to the HCI node 104). The affiliated resource 1202 refers to each title of the resources affiliated with the HCI nodes 103 to 105 as specified by the node ID 1201, respectively. The structure information table 309 is not limited to the table of FIG. 12, but may be generated in an arbitrary form so long as the structure information indicates the relation between the resources.

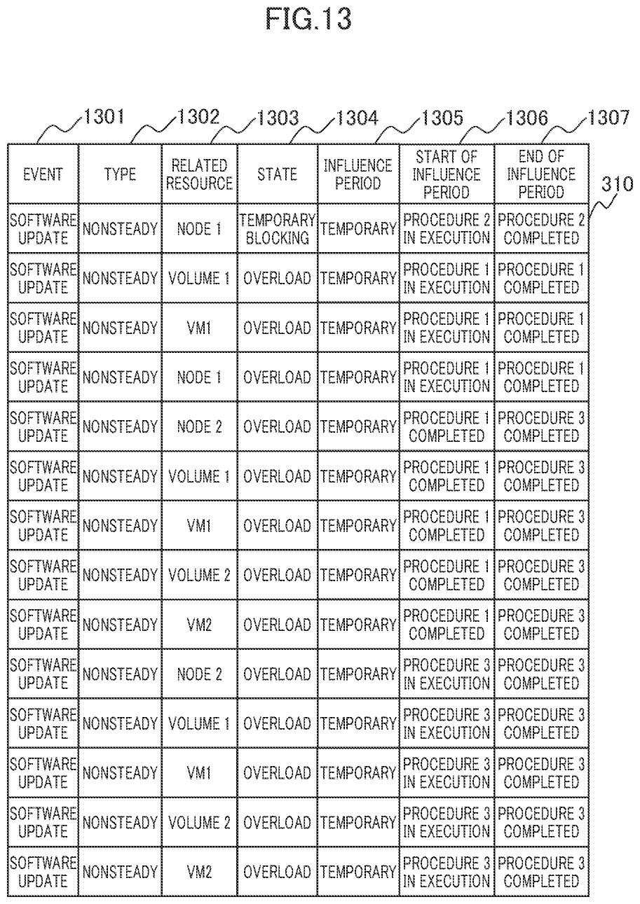

FIG. 13 illustrates a structure of the event management table 310 of the computer system S according to the first example.

The event management table 310 includes entries of an event 1301, a type 1302, a related resource 1303, a state 1304, an influence period 1305, a start of influence period 1306, and an end of influence period 1307.

The event 1301 and the type 1302 are the same as the event 601 and the type 602 of the event type table 305, respectively. The related resource 1303 refers to a title of the resource related to the event as specified by the event 1301. The state 1304 refers to a state of the resource as specified by the related resource 1303. The influence period 1305 is the same as the influence period 603 of the event type table 305. The start of the influence period 1306 refers to the timing of starting the period for which the resource specified by the related resource 1303 is influenced by the event as specified by the event 1301. The end of the influence period 1307 refers to the timing of the end of the period for which the resource as specified by the related resource 1303 is influenced by the event as specified by the event 1301. An example of FIG. 13 indicates the timing determined by in-execution/completed state of the numbered software updating procedure (the same as the procedure number as specified by the execution procedure 701 of the software update management table 306).

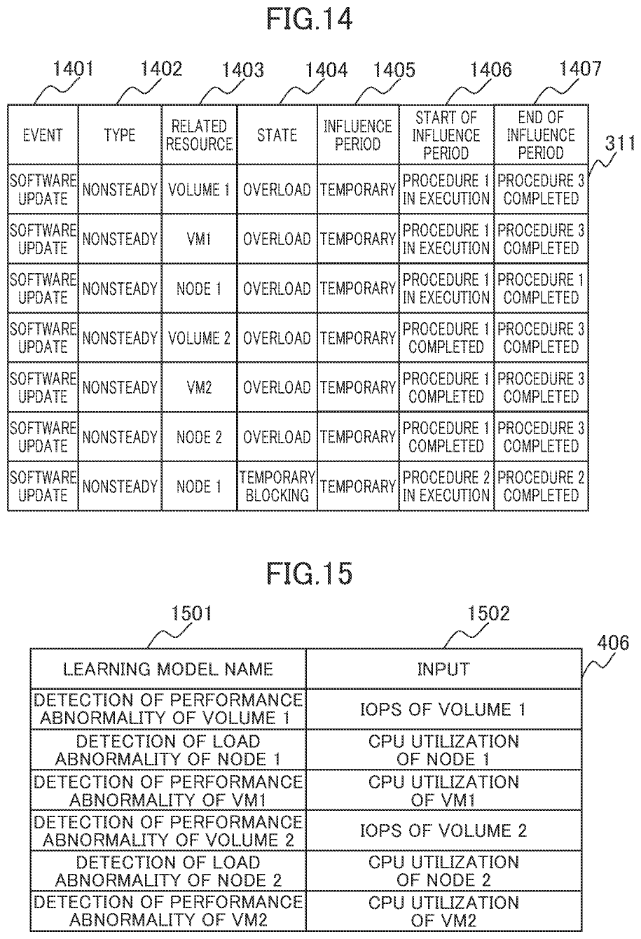

FIG. 14 illustrates a structure of the event notification table 311 of the computer system S according to the first example. The event notification table 311 is generated by the event processing program 114 for arranging the respective columns of the event management table 310 of FIG. 13.

FIG. 15 illustrates a structure of the learning model management table 406 of the computer system S according to the first example.

The learning model management table 406 includes entries of a learning model name 1501 and an input 1502. The learning model name 1501 refers to a title of the learning model 405. The input 1502 refers to a title representing the value to be input to the learning model as specified by the learning model name 1501.

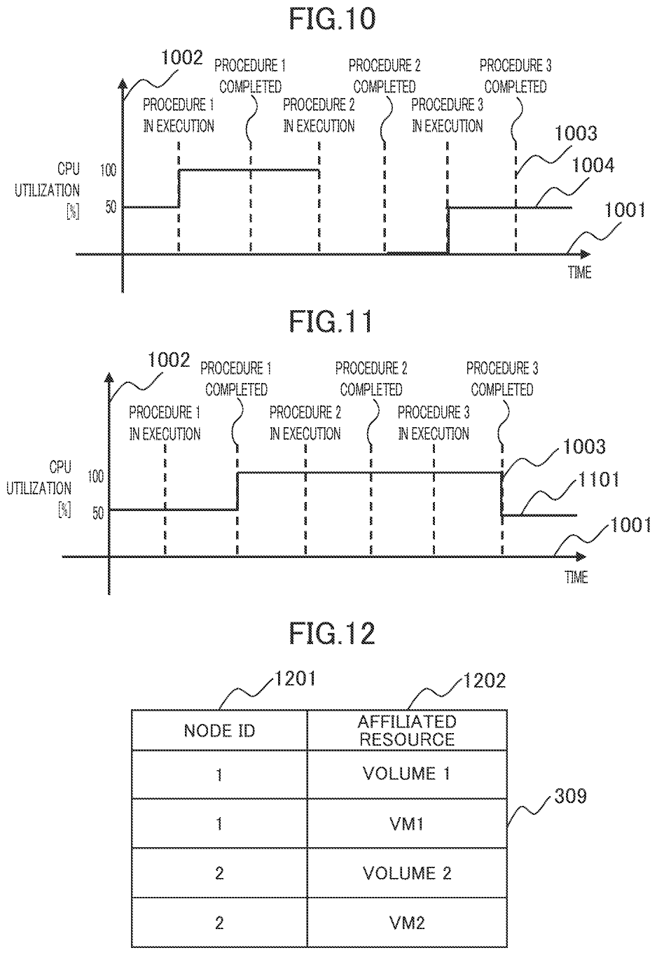

Operations of the computer system S of the example will be described referring to flowcharts of FIGS. 16 to 20, and FIGS. 10, 11.

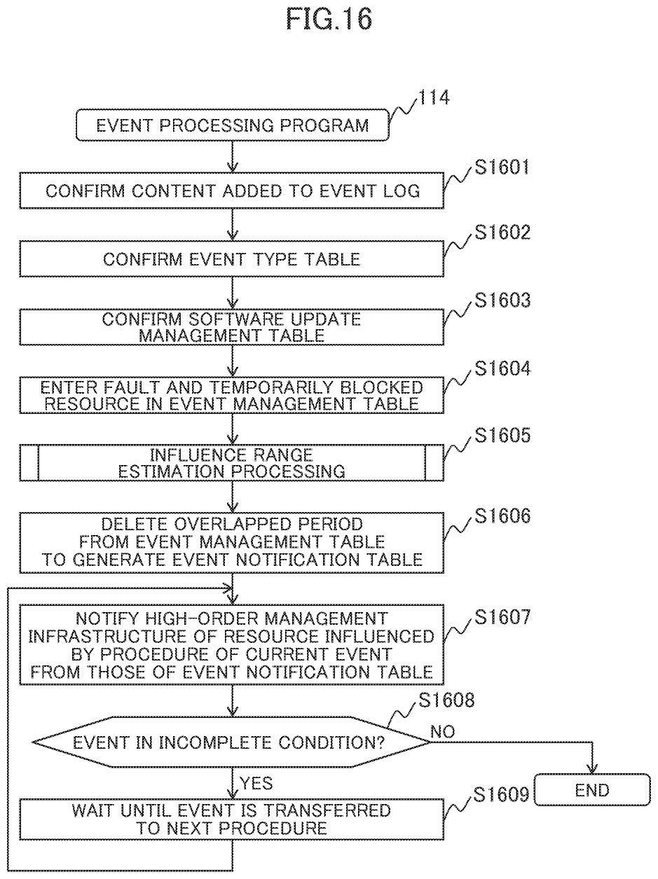

FIG. 16 is a flowchart representing event processing steps executed in the computer system S according to the first example. The processing steps of the flowcharts in FIGS. 16 to 19 are executed by the event processing program 114 of the HCI nodes 103 to 105.

The event processing program 114 confirms the content added to the event log 304 (S1601). The event processing program 114 then confirms the event type table 305 (S1602). The event processing program 114 further confirms the software update management table 306, and enters the fault and the temporarily blocked resource into the event management table 310 (S1604).

The event processing program 114 executes estimation processing of an influence range of the processing in the HCI cluster 101 (S1605). The detailed explanation of the influence range estimation processing will be made later.

It is assumed that the certain processing starts influencing a resource immediately after the end of the influence of the other processing to the resource. This case implies that the resource is continuously influenced rather than intermittently while having the start and the end intervened. Therefore, notification to the high-order management infrastructure 100 does not have to be transmitted. The event processing program 114 generates the event notification table 311 by excluding data with respect to the overlapped period from the event management table 310 so as to avoid unnecessary notification (S1606). The event processing program 114 notifies the high-order management infrastructure 100 of the resource to be influenced by the procedure of currently executed event from those of the event notification table 311 generated in S1606 (S1607).

The event processing program 114 determines whether or not the currently executed event has been an incomplete condition (S1608). If it is determined that the event has been in the incomplete condition (YES in S1608), the program proceeds to S1609. If it is determined that the event has been in the completed condition (NO in S1608), the processing of the flowchart in FIG. 16 ends.

In S1609, the program waits until the event proceeds to the next procedure, and returns to S1607.

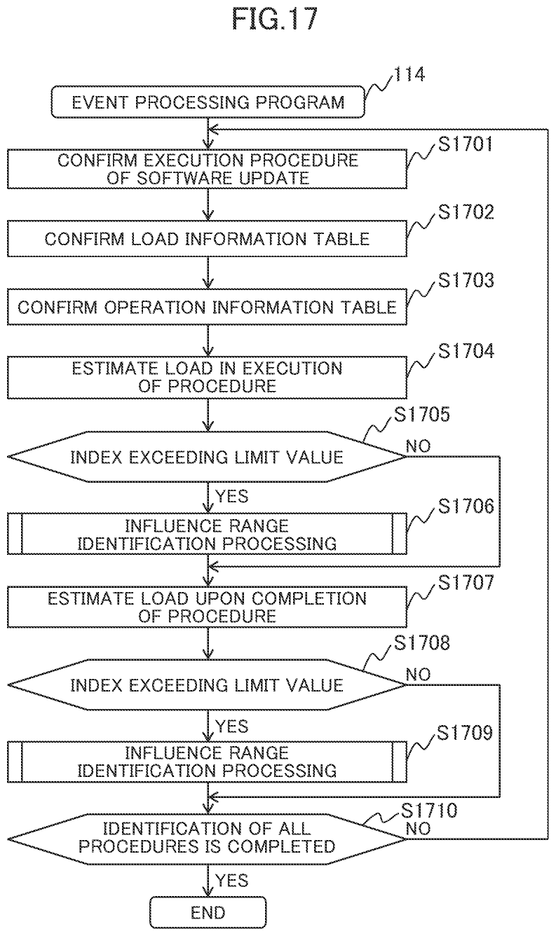

FIG. 17 is a flowchart representing the influence range estimation processing steps executed in the computer system S according to the first example. The flowchart of FIG. 17 constitutes detailed steps corresponding to S1605 of FIG. 16.

The event processing program 114 confirms the execution procedure of the software update referring to the software update management table 306 (S1701). The event processing program 114 confirms the load information table 307 (S1702). The event processing program 114 confirms the operation information table 308 (S1703).

The event processing program 114 estimates the load applied during execution of the specific procedure (S1704). For example, the event processing program 114 estimates transition of the CPU utilization of the node 1 (HCI node 103) as illustrated in FIG. 10.

Referring to FIG. 10, a horizontal axis 1001 refers to the time, and a vertical axis 1002 refers to the CPU utilization to be estimated. A dotted line 1003 refers to the time at which the respective software updating steps are executed. The software update is started by executing the procedure 1. As the software update management table 306 of FIG. 7 indicates, in the procedure 1, the volume 1 (volume 107) and the VM1 (VM 106) of the node 1 (HCI node 103) are moved to the node 2 (HCI node 104). Accordingly, it is estimated that the CPU utilization is increased by 50% owing to movement of the volume and the VM of the load information table 307 so that the CPU utilization of the node 1 becomes 100%.

FIG. 11 illustrates the estimated transition of the estimated CPU utilization of the node 2 (HCI node 104). In FIG. 11, the horizontal axis 1001 refers to the time, and the vertical axis 1002 refers to the CPU utilization to be estimated. The dotted line 1003 refers to the time at which the respective software updating steps are executed. The volume 1 (volume 107) and the VM1 (VM 106) are moved to the node 2 (HCI node 104) in the procedure 1. Accordingly, in the procedure 1 and thereafter including processing of the volume 2 (volume 109) and the VM2 (VM 108) which have been stored in the node 2, it is estimated that the CPU utilization of the node 2 (HCI node 104) becomes 100%.

Referring back to FIG. 17, the event processing program 114 determines whether or not the index estimated in S1704 exceeds a limit value (S1705). The limit value may be the predetermined default value, or set by the manager. For example, the limit value of the CPU utilization may be set to 100%. If it is determined that the index exceeds the limit value (YES in S1705), the program proceeds to S1706. If it is determined that the index does not exceed the limit value (NO in S1705), the program proceeds to S1707.

In S1706, the event processing program 114 executes the processing for identifying the influence range of the processing to be executed in the HCI cluster 101. The detailed explanation of the influence range identification processing will be made later.

In S1707, the event processing program 114 estimates the load applied upon completion of the procedure. The event processing program 114 determines whether or not the index estimated in S1707 exceeds the limit value (S1708). If it is determined that the index exceeds the limit value (YES in S1708), the program proceeds to S1709. If it is determined that the index does not exceed the limit value (NO in S1708), the program proceeds to S1710.

In S1709, the event processing program 114 executes the processing for identifying the influence range of the processing executed in the HCI cluster 101.

In S1710, the event processing program 114 determines whether or not identification of all procedures has been completed. If it is determined that the identification of all procedures has been completed (YES in S1710), the processing of FIG. 17 ends. If it is determined that the identification of all procedures has not been completed (NO in S1710), the program returns to S1701.

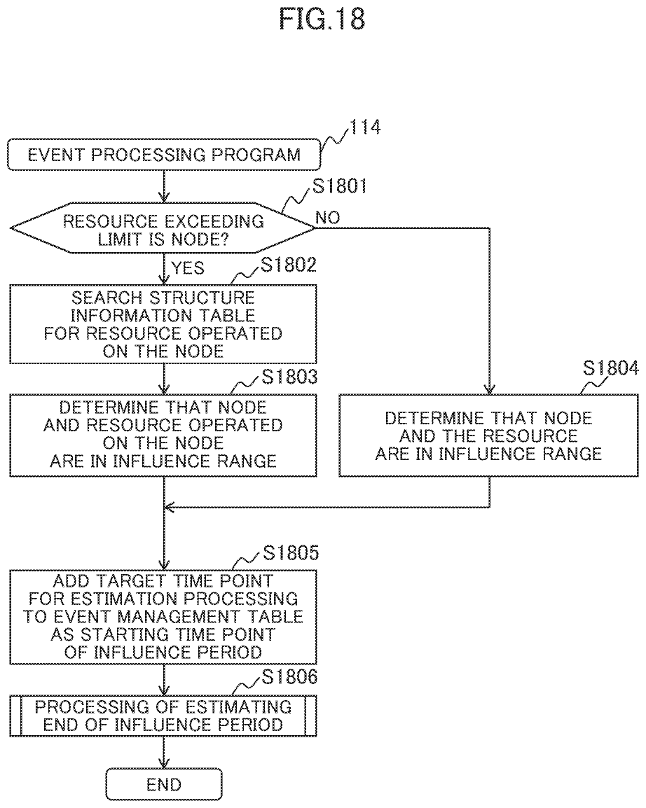

FIG. 18 is a flowchart representing the influence range identification processing steps executed in the computer system S according to the first example. The flowchart of FIG. 18 constitutes detailed steps corresponding to S1707, S1709 of FIG. 17.

The event processing program 114 determines whether or not the resource having the index exceeding the limit value is the node (S1801). As the processing of the flowchart of FIG. 18 is started upon determination that the index has exceeded the limit value in S1705 and S1708 of FIG. 17, determination is made whether or not the resource determined to have the index exceeding the limit value is the node. If it is determined that the resource having the index exceeding the limit value is the node (YES in S1801), the program proceeds to S1802. If it is determined that the resource having the index exceeding the limit value is not the node (the resource is the volume or the VM in the example) (NO in S1801), the program proceeds to S1804.

In S1802, referring to the structure information table 309, the event processing program 114 searches the resource operating on the target node. The event processing program 114 determines that the node and the resource operating on the node are in the influence range (S1803).

Meanwhile, in S1804, the event processing program 114 determines that the operating resource having the index exceeding the limit value is in the influence range.

The event processing program 114 adds the target time point of executing estimation processing to the event management table 310 as the time point of starting the influence period. Then the event processing program 114 executes the processing to estimate the time point of the end of the influence period for which the processing is executed in the HCI cluster 101 (S1806). Detailed explanation of the processing for estimating the end time point of influence period will be made later. The processing of FIG. 18 then ends.

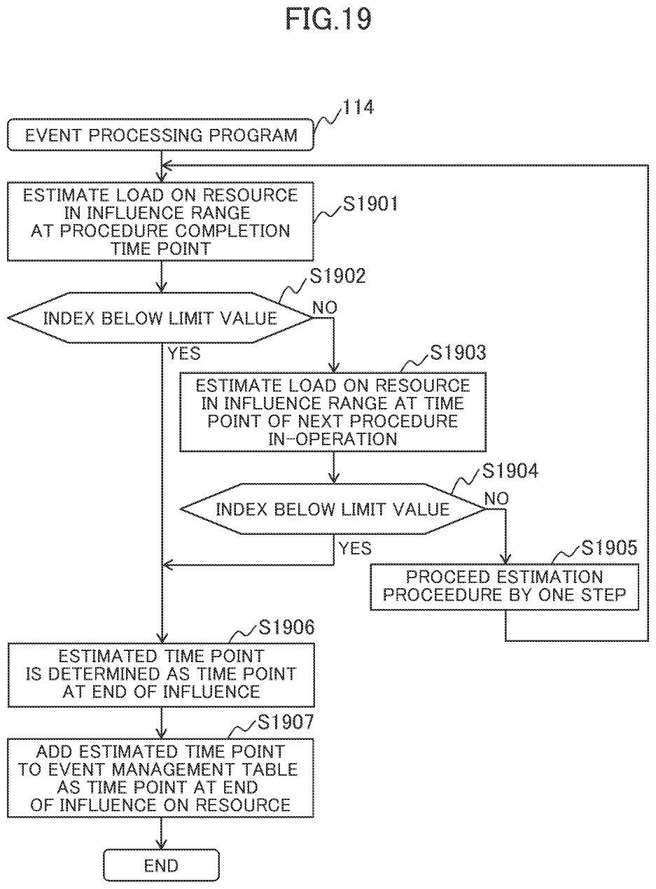

FIG. 19 is a flowchart representing the influence end time point estimation processing steps executed in the computer system S according to the first example. The flowchart of FIG. 19 constitutes detailed steps corresponding to S1806 of FIG. 18.

The event processing program 114 estimates the load applied to the resource to be influenced upon completion of the procedure as the current estimation target having the index exceeding the limit value as the determination basis (S1901). Specifically, if the resource to be influenced is the node, the load generated by operations of the other resource of the node upon completion of the procedure as the current estimation target is estimated with reference to the value 903 of the operation information table 308 at the event starting time point (for example, if the VM and the volume are moved to the node to be estimated from the other node, the value 903 of the node as the movement source is added to the value 903 of the node). As for the other resource, the value 903 of the operation information table 308 at the event starting time point in such resource is set to the estimated value. The event processing program 114 determines whether or not the index estimated in S1901 is below the limit value (S1902). If it is determined that it is below the limit value (YES in S1902), the program proceeds to S1906. If it is determined that it is not below the limit value (NO in S1902), the program proceeds to S1903.

In S1903, the load to the resource to be influenced is estimated at a timing of executing the procedure subsequent to the one estimated in S1901. Specifically, if the resource to be influenced is the node, the load generated in execution of the procedure to be estimated is set to the value 804 of the load information table 307. The estimation processing is executed by adding the load generated in operation of the other resource of the node as the value 903 of the operation information table 308 at the event starting time point (for example, it is assumed that the VM and the volume are moved to the node to be estimated from the other node. In the case of estimating the load in execution of the procedure for moving the VM and the volume to the node at the movement source, similarly to S1901, the value 903 of the node at the movement source is added to the value 903 of the node. Furthermore, the value 804 derived from the volume movement and the value 804 derived from the VM movement are added up). As for the other resource, the value 903 of the operation information table 308 at the event starting time point of the resource is added to the value 804 of the load information table 307 in execution of the processing by the resource. The event processing program 114 determines whether or not the index estimated in S1903 is below the limit value (S1904). If it is determined that it is below the limit value (YES in S1904), the program proceeds to S1906. If it is determined that it is not below the limit value (NO in S1904), the program proceeds to S1905. In S1905, the processing of the target estimation procedure is advanced by one step. The program then returns to S1901.

In S1906, the event processing program 114 determines the time point of the target estimation procedure (either in-execution or completion of execution) as the time point of end of the influence period. The event processing program 114 adds the estimated time point to the event management table 310 as the time point of end of the influence period (S1907).

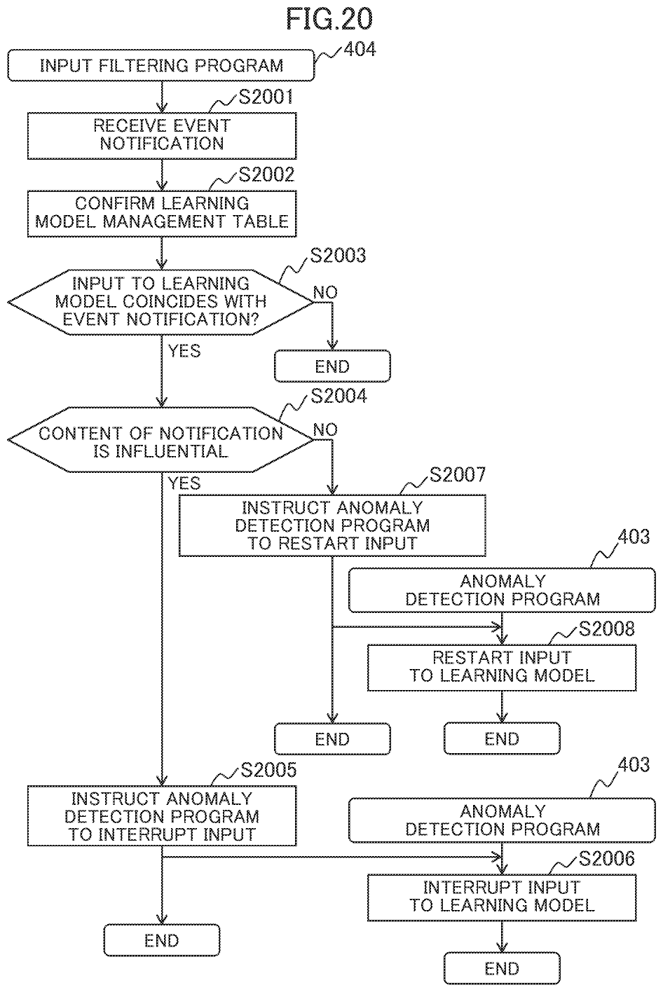

FIG. 20 is a flowchart representing the input determination processing steps executed in the computer system S according to the first example. The processing of the flowchart in FIG. 20 is executed by the input filtering program 404 and the anomaly detection program 403 of the high-order management infrastructure 100.

The input filtering program 404 receives the event notification table 311 from the HCI cluster 101 (S2001). The input filtering program 404 confirms the learning model management table 406 (S2002).

Referring to the event notification table 311 received in S2001 and the learning model management table 406, the input filtering program 404 determines whether or not the content of the event notification table 311 coincides with the input 1502 of the learning model management table 406 (S2003). If it is determined that the content coincides with the input 1502 (YES in S2003), the program proceeds to S2004. If it is determined that the content does not coincide with the input 1502 (NO in S2003), the processing of FIG. 20 ends.

In S2004, it is determined whether or not the event notification table 311 as the content of notification from the HCI cluster 101 is influential in the anomaly detection program 403. If it is determined to be influential (YES in S2004), the program proceeds to S2005. If it is determined not to be influential (NO in S2004), the program proceeds to S2007.

In S2005, an input interruption instruction is sent to the anomaly detection program 403. In response to the input interruption instruction, the anomaly detection program 403 interrupts the input to the learning model 405 (S2006). The processing of FIG. 20 then ends.

In S2007, an input restart instruction is sent to the anomaly detection program 403. In response to the input restart instruction, the anomaly detection program 403 restarts the input to the learning model 405 (S2008).

In the example as configured above, application of the normal state learned through the machine learning to the abnormality detection, the data which are not in the normal state may be excluded. When the anomaly detection program 403 executes the abnormality detection based on the learning model 405, it is possible to reduce the confirmation task resulting from the intrinsically unnecessary notification.

### SECOND EXAMPLE

In a second example, in addition to the operation information table 308 in the first example, the operation information collection program 117 records entries of the states 1304, 1404 in the event management table 310 and the event notification table 311 according to the first example, respectively.

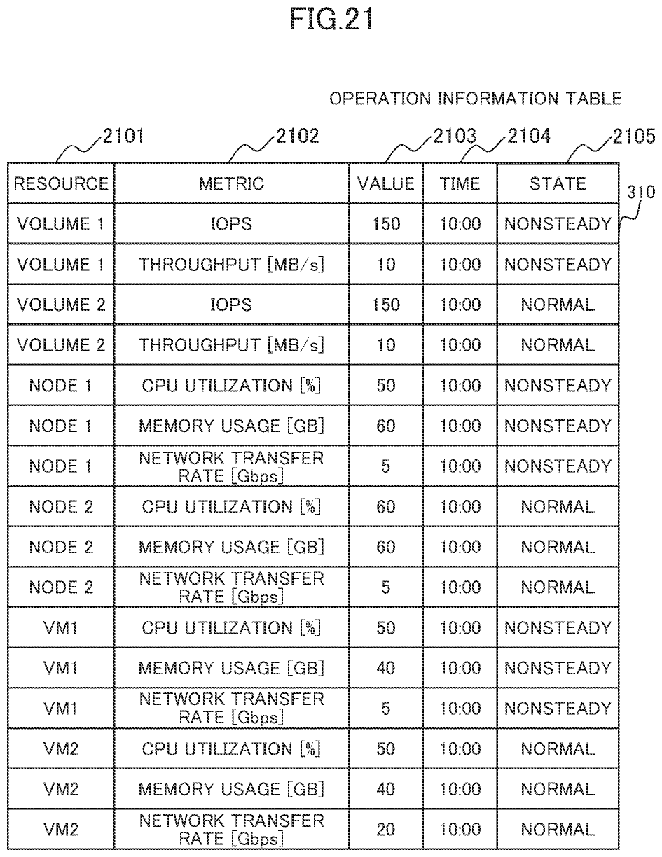

FIG. 21 illustrates a structure of the operation information table 308 of the computer system S according to the second example.

The operation information table 308 includes entries of a resource 2101, a metric 2102, a value 2103, a time 2104, and a state 2105.

As the resource 2101, the metric 2102, the value 2103, and the time 2104 are the same as the corresponding entries of the operation information table 308 according to the first example of FIG. 9, explanations of those entries will be omitted. The state 2105 has the same contents as those of the entries including states 1304, 1404 of the event management table 310 and the event notification table 311 according to the first example of FIGS. 13 and 14, respectively.

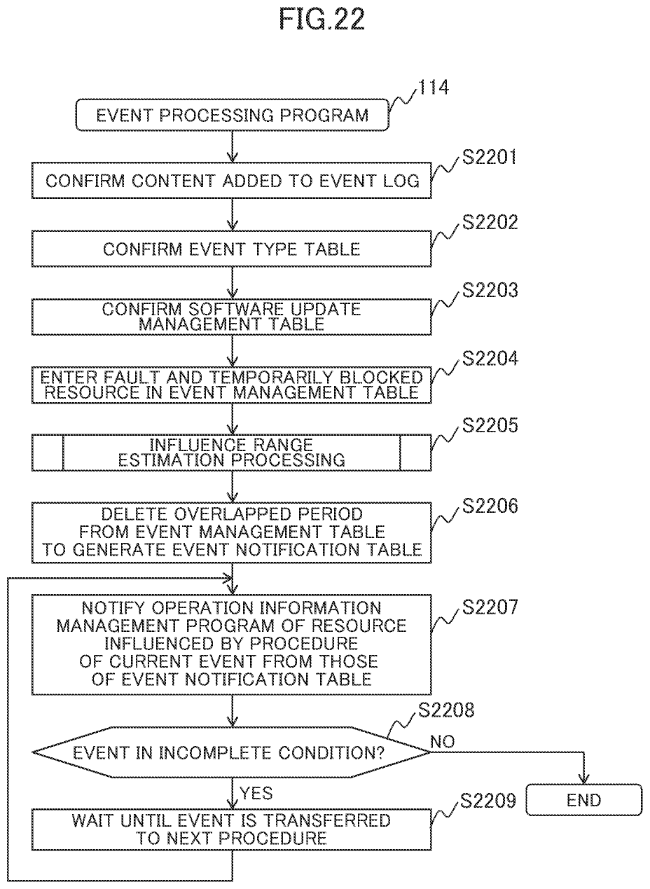

FIG. 22 is a flowchart representing the event processing steps executed in the computer system S according to the second example. The event processing steps of the flowchart of FIG. 22 is substantially the same as the event processing steps according to the first example of the flowchart in FIG. 16 except the processing step of 52207. The explanation only of the different part will be made.

The event processing program 114 notifies the operation information management program 302 of the resource influenced by the procedure of the currently executed event from those of the event notification table 311 generated in S2206 (S2207). In other words, in the first example, the notification is sent to the high-order management infrastructure 100. Meanwhile, in the second example, upon reception of the request of providing the operation information table 308 from the high-order management infrastructure 100, the operation information table 308 together with the state 2105 will be provided to the high-order management infrastructure 100.

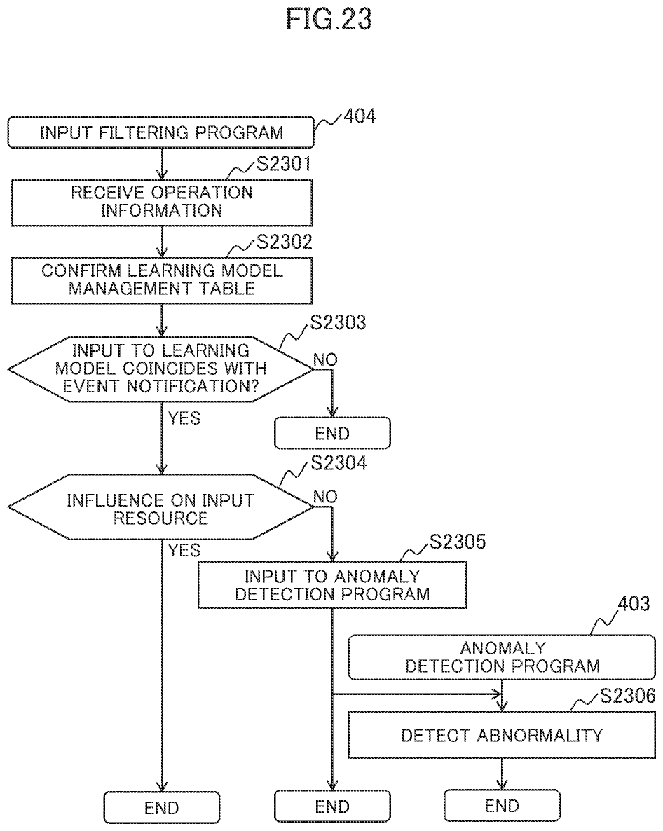

FIG. 23 is a flowchart representing the input determination processing steps executed in the computer system S according to the second example.

The input filtering program 404 receives the operation information table 308 from the HCI cluster 101 (S2301). The input filtering program 404 then confirms the learning model management table 406 (S2302).

Referring to the operation information table 308 received in S2401 and the learning model management table 406, the input filtering program 404 determines whether or not the content of the operation information table 308 coincides with the input 1502 of the learning model management table 406 (S2303). If it is determined that the content coincides with the input 1502 (YES in S2303), the program proceeds to S2304. If it is determined that the content does not coincide with the input 1502 (NO in S2303), the processing of FIG. 23 ends.

In S2304, the input filtering program 404 determines whether or not the content of the operation information table 308 is influential in the input resource. If it is determined that the content is influential (YES in S2304), the processing of FIG. 23 ends. If it is determined that the content is not influential (NO in S2304), the program proceeds to S2305.

In S2305, the input filtering program 404 determines to input the content of the operation information table 308 to the anomaly detection program 403. Based on the operation information table 308, the anomaly detection program 403 executes the abnormality detection processing (S2306). The processing of FIG. 23 then ends.

The example provides effects similar to those derived from the first example.

### THIRD EXAMPLE

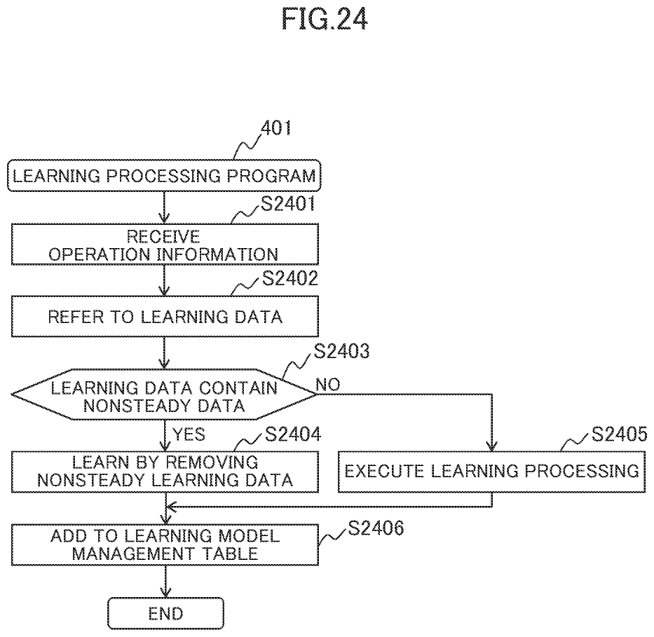

FIG. 24 is a flowchart representing the input determination processing steps executed in the computer system S according to a third example.

The input filtering program 404 receives the operation information table 308 from the HCI cluster 101 (S2401). The input filtering program 404 then confirms the learning data 407 (S2402).

Referring to the operation information table 308 received in S2401, and the learning data 407, the input filtering program 404 determines whether or not nonsteady data are contained in the learning data 407 (S2403). If it is determined that the nonsteady data are contained (YES in S2403), the program proceeds to S2404. If it is determined that the nonsteady data are not contained (NO in S2403), the program proceeds to S2405.

In S2404, the learning processing program 401 learns based on the operation information table 308 while excluding the nonsteady learning data 407. Meanwhile, in S2405, the learning processing program 401 learns based on the operation information table 308.

The learning processing program 401 adds the learned content to the learning model management table 406.

The example provides effects similar to those derived from the first example.

In the third example, learning is carried out by excluding the nonsteady data. However, the nonsteady data may be used for learning the nonsteady state.

### FOURTH EXAMPLE

This example will be described with respect to the case that the influence period 1305 as specified by the event management table 310 is permanent. Although the processing procedure to be executed in the HCI cluster 101 in this example is basically the same as the one according to the first example, the high-order management infrastructure 100 is notified of the permanent influence. The high-order management infrastructure 100 allows the input filtering program 404 to execute the same processing as the one executed in the first example. If the notification content in S2004 of FIG. 20 is influential (YES in S2004), it is additionally determined whether or not the influence period is permanent. If it is determined that the influence period is permanent, abnormality is detected through the input to the learning model. If it is determined that the influence period is not permanent, the program proceeds to S2005.

The foregoing examples have been described in detail for readily understanding of the present invention which is not necessarily limited to the one equipped with all structures as described above. It is possible to add, remove, and replace a part of the structure of the respective examples to, from and with the other structure.

The respective structures, functions, processing parts, processing means and the like may be implemented through hardware by designing those elements partially or entirely using the integrated circuit. The respective functions of the examples may also be implemented through the program code of software. In this case, the computer is provided with the storage medium having the program codes recorded therein so that the processor of the computer reads the program code stored in the storage medium. In this case, the program code read from the storage medium serves to implement functions of the foregoing examples. Accordingly, the program code itself and the storage medium that stores such code form the present invention. The storage medium for providing the program code includes, for example, the flexible disc, CD-ROM, DVD-ROM, hard disk, SSD (Solid State Drive), optical disc, magnetooptical disk, CD-R, magnetic tape, non-volatile memory card, and ROM.

The program code that implements the functions as specified in the examples may be installed through the wide-range program or the script language, for example, the assembler, C/C++, perl, Shell, PHP, and Java®.

The foregoing examples show the control lines and information lines which are considered as necessary for the explanation. However, they do not necessarily indicate all the control lines and the information lines of the product. All the structures may be interconnected with one another.

1. A computer system including at least one processor, and a management server which is configured to be communicable with the processor, and to acquire operation information of the processor for executing an abnormality detection of the processor, wherein:
the processor generates an event notification table including a resource of the processor relevant to an event executed in the processor, and a type of influence of the event to the processor computer unit, and transmits the event notification table to the management server,
the operation information includes a load to the resource of the processor,
the management server executes the abnormality detection of the processor using the operation information and the event notification table,
on a first type of influence, the management server sends an interruption signal to the processor, and the processor interrupts a learning model,
on a second type of influence, a restart instruction is sent to the processor and the processor restarts the learning model, and
the processor includes the learning model for generating outputs in response to input operations.

2. The computer system according to claim 1, wherein:
the event notification table further includes a type of the event; and
the type of influence includes a state of the influence corresponding to one of a steady state, a nonsteady state, and a fault state, and an influence period.

3. The computer system according to claim 1, wherein:
the processor generates an operation information table including the event executed in the processor, and the resource relevant to the event, and transmits the operation information table as the operation information to the management server.

4. The computer system according to claim 1, wherein the processor generates the event notification table in response to execution of the event.

5. The computer system according to claim 1, wherein the processor generates an event management table including a type of the event executed in the processor, the resource of the processor relevant to the event, the influence of the event to the processor, and a period of the influence, and generates the event notification table by excluding an overlapped period of the influence from the event management table.

6. The computer system according to claim 1, wherein the processor transmits the event notification table to the management server in response to a request from the management server.

7. The computer system according to claim 1, wherein:
an event management table of the processor includes an influence period; and
if the influence period is temporal, the management server executes the abnormality detection using the operation information with respect to a period having the influence period excluded.

8. The computer system according to claim 7, wherein if the influence period is continuous, the management server executes the abnormality detection with respect to a period including the influence period.

9. An event management method for a computer system including at least one processor, and a management server which is configured to be communicable with the processor, and to acquire operation information of the processor for executing an abnormality detection of the processor, the event management method comprising:
generating an event notification table including a type of an event executed in the processor, a resource of the processor relevant to the event, an influence of the event to the processor, and a period of influence,
transmitting the event notification table to the management server; and
executing the abnormality detection of the processor using the operation information and the event notification table.
